(19) United States
(12) Patent Application Publication
(10) Pub. No.: US 2006/0271292 A1
(43) Pub. Date: Nov. 30, 2006

(54) Mobile Geographical Information Display System

(76) Inventor: Michael Andrew Buck, Oxley (AU)

Correspondence Address: ENB Pty Ltd, Suite 21, 36 Agnes Street, Fortitude Valley, Queensland, 4006, AU

(21) Appl. No.: 11/421,769

(22) Filed: Jun. 2, 2006

(30) Foreign Application Priority Data
Dec. 2, 2004 (WO) PCT/AU04/01698
Dec. 2, 2003 (NZ) 529890

(51) Int. Cl. G01C 21/00

(52) U.S. Cl. 701/213

(57) ABSTRACT

A wearable geographical information display assembly includes a heads-up display 4 to which is mounted an attitude sensor 22. Both heads-up display 4 and attitude sensor 22 are coupled with a cellular phone 10 of a type that receives geographical positioning data from orbital satellites 12. Positional data, and data indicating line of sight from attitude sensor 22 are transmitted from cell phone 10 to a telecommunications company 16. The company retrieves display data corresponding to the received positional and line of sight data from a database 18. The display data is transmitted back to cell phone 10 and displayed by means of heads-up display 4.

Priority is claimed from PCT/AU2004/001698 having the international filing date of 2 Dec. 2004 and claiming priority from New Zealand Patent Application No. 529890 filed 2 Dec. 2003.

### FIELD OF THE INVENTION

The present invention relates to the display of geographically relevant information.

### BACKGROUND TO THE INVENTION

The present invention addresses a variety of problems.

For example, in the last thirty years international travel has increased as airline fares have fallen. At the same time, the amount of free time available to travellers has decreased so that when a traveller arrives in a foreign destination he or she will wish to make the best use of their time. In particular, time lost due to losing one's way or through failure to identify an important landmark may be a particular source of irritation.

An associated problem is that travellers may be unaware of the historical or cultural significance of buildings and areas that they pass by. Consequently their visit may be less enriching than would be the case if historical and cultural landmarks were brought to their attention.

A further problem is due to the fact that different travellers have different interests. For example a traveller that is particularly interested in sports may find particular areas of a city more interesting than a traveller that is particularly interested in antiques or in certain types of restaurant. Nevertheless, as a traveller strolls through a city he or she may well inadvertently pass areas that would be of particular interest.

It is an object of the present invention to provide a system that addresses at least some of the above described problems.

### SUMMARY OF THE INVENTION

According to a first aspect of the present invention there is provided a wearable geographical information display assembly including:
a headset including a heads-up display;
a sensing assembly fast with the heads-up display and arranged to generate positional data indicating a line of sight of a wearer of the headset; and
a wireless computational device arranged to communicate with the sensing assembly and to communicate the positional data to a remote database by means of a cellular telecommunications network, said computational device being further arranged to drive the heads-up display to present display data retrieved from the remote database in response to the positional data.

Preferably the sensing assembly includes an attitude detector.

In addition the sensing assembly may include an eyeball tracking means.

In a preferred embodiment the wearable geographical information display assembly further includes a geographical positioning system (GPS) receiver.

The wireless computational device will typically comprise a cell phone.

Preferably the GPS receiver is incorporated into the cell phone.

According to a further aspect of the present invention there is provided a method for displaying geographical information to a subject including the steps of:
determining positional data indicating a line of sight of the subject;
retrieving, by means of a cellular telecommunications network, geographical data corresponding to the positional data from a database; and
superimposing a display corresponding to the geographical data into the visual field of the subject.

In a preferred embodiment of the invention the step of determining positional data includes determining the attitude of a headset worn by the subject.

The step of determining positional data may also include determining the geographical location of the subject.

Preferably the step of determining positional data includes tracking the eyeball of the subject.

In one embodiment of the invention the method includes the step of updating the database with a geographical position of the subject.

The method may also include the step of transmitting a filter parameter to the data source.

Further preferred features of the present invention will be described in the following detailed description which will refer to a number of figures as follows.

### BRIEF DESCRIPTION OF THE DRAWINGS

FIG. 1 depicts a geographical visualization system according to a preferred embodiment of the present invention.

FIG. 2 depicts the geographical visualization system of FIG. 1 in use.

### DETAILED DESCRIPTION OF EXEMPLARY EMBODIMENTS

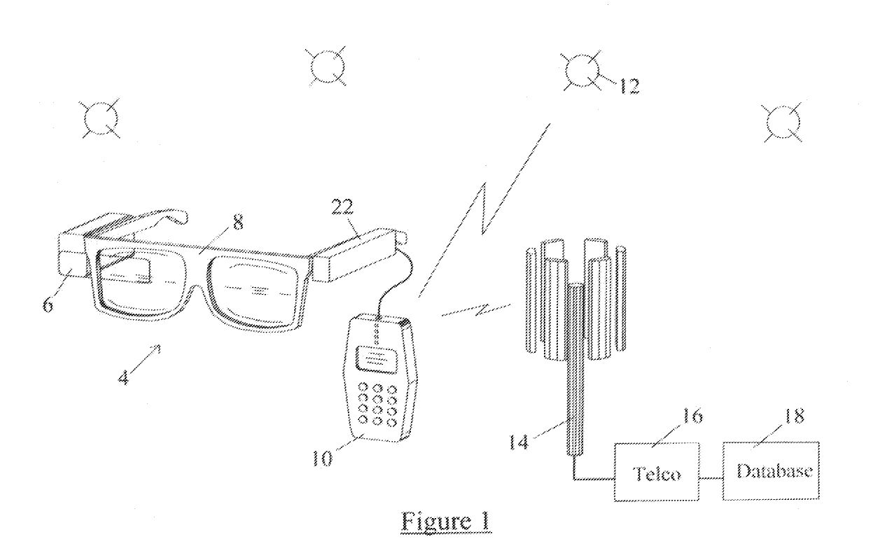

FIG. 1 depicts the components of a wireless geographical display system (WGDS) 2 according to a preferred embodiment of the invention. The WGDS includes wearable geographical information display assembly including a headset 4 which is typically provided in the form of a pair of spectacle frames 8 to which a heads-up imaging system 6 is fixed. A commercially available heads-up imaging system is the M1100 produced by Interactive Imaging Systems, Inc. of 2166 Brighton Henrietta Townline Road, Suite B Rochester, N.Y. 14623. USA The M1100 is a 640×480 colour VGA capable heads-up display unit that weighs less than 50 grams and produces a display that may be adjusted to appear at anywhere between two and fifteen feet to a wearer of the display.

Headset 4 further includes an attitude sensor 22 which is fixed to spectacle frames 8 and which generates a digital signal indicating the orientation of the heads-up unit 4. Crossbow Technology, Inc. of 41 Daggett Dr. San Jose, Calif. 95134 USA manufacture a suitable micro-orientation sensor model CXM544. Imaging system 6 and attitude sensor 8 are both coupled to a wireless computational device in the form of a cellular phone 10. Cell phone 10 includes an onboard position determining system which in the presently described embodiment is in the form of a GPS receiver that produces location data on the basis of signals received from orbiting satellites 12.

Cell phone 10 is in wireless communication with a telephone network 16 via cell antenna installation 14. Telephone network 16 and antenna installation 14 are used to relay data between cell phone 10 and a geographical information data source 18. The geographical information data source 18 will typically be a computer system supporting a relational database.

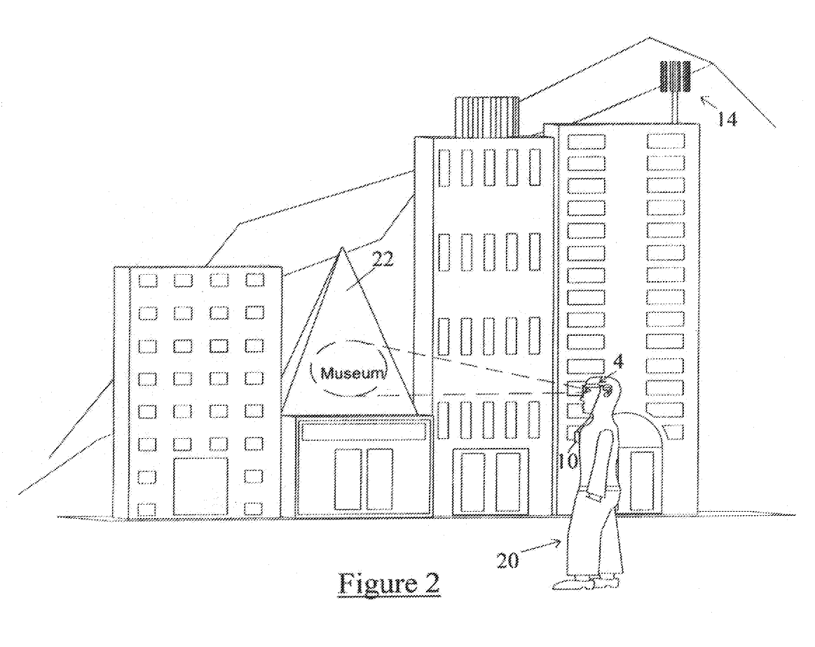

With reference to FIG. 2, in use a subject 20 wears heads-up unit 4 and cell phone 10. After a first initialisation phase at switch-on, cell phone 10 establishes communication with telephone network 16 via antenna installation 14. Cell phone 10 then transmits positional data to telephone network 16 in the form of attitude data from attitude sensor 8 and GPS location data derived from satellites 12. User 20 may enter filter parameters into cell phone 10 which are transmitted to telephone network 16 along with the positional data. The filter parameters will typically be parameters indicating the nature of the geographical information that subject 20 is interested in.

The positional data, and any filter parameters, from cell phone 10 are relayed to data source 18 and corresponding geographical data is retrieved. The corresponding geographical data is relayed back to cell phone 10 which drives imaging assembly 6 in order produce a display corresponding to the retrieved data to subject 10. In the example of use presently described with reference to FIG. 2, subject 20 has configured cell phone 10 so that the filter parameters are set to retrieve geographical data relating to cultural landmarks. Consequently, in response to subject 20 moving his head to look at building 22, for example, data source 18 is interrogated to determine if a culturally significant area is in the subject's line of sight. In this particular instance data source 18 determines that a museum is in the subject's line of sight. That geographical data is relayed back to cell phone 10 which in turn drives imaging system 6 to display the descriptive word “MUSEUM” in the subject's language. As a result subject 20 sees the word “MUSEUM” in front of building 22 and may decide to visit the building. Later in the day, for example at lunchtime, the subject may change the filter parameter choice so that geographical information relating to restaurants is retrieved from database 18.

It will be realised that although it is envisaged that a system according to the present invention would typically make use of GPS and cell phone communication other positioning systems and data communication links are possible. For example, differential GPS might be used to more accurately locate a wearer of the apparatus in particular geographical regions. Alternatively, terrestrially based location systems might be used as an alternative. Furthermore, headset 4 might also include an eyeball tracking assembly to more precisely determine a wearer's line of sight.

In a further embodiment of the invention database 18 may be dynamically updated with the geographical position of the subject along with a unique identifier for cell phones 10. In that case a person wearing a system according to the present invention might enter a filter parameter corresponding to another individual's, or group of individual's identifiers. Consequently a visual display corresponding to the presence of the individual, or member of the group of individuals, will be generated as a wearer of the system changes his or her line of sight.

In yet another embodiment of the invention computational device 10, which in the preferred embodiment is a cell phone, is configured to retrieve the geographical information from a data source which is onboard, rather than remote database 18. For example, computational device 10 may retrieve the geographical information from a memory device such as a smart card loaded with the geographical information for a particular region that subject 20 is operating in. Upon subject 20 leaving that area a different card must be inserted into device 10.

Alternatively, computational device 10 may instead comprise a wireless device, such as a cell phone as previously described, which downloads all the geographical data for a particular region into an onboard memory device at the time of subject 20 entering the particular geographical region. Downloading the data in one hit reduces the amount of data, and associated time delay, that must be passed back and forth between device 10 and database 18. Of course, if this option is used then the data in device 10 will not be the most current version available.

It will, of course, be realized that the above has been given only by way of illustrative example of the invention and that all such modifications and variations thereto as would be apparent to persons skilled in the art are deemed to fall within the broad scope and ambit of the invention as summarised in the following claims.

I claim:

1. A wearable geographical information display assembly including:
a headset including a heads-up display;
a sensing assembly fast with the heads-up display and arranged to generate positional data indicating a line of sight of a wearer of the headset; and
a wireless computational device arranged to communicate with the sensing assembly and to communicate the positional data to a remote database by means of a cellular telecommunications network, said computational device being further arranged to drive the heads-up display to present display data retrieved from the remote database in response to the positional data.

2. An assembly according to claim 1, wherein the sensing assembly includes an attitude detector.

3. An assembly according to claim 1, wherein the sensing assembly includes an eyeball tracking means.

4. An assembly according to claim 1, including a geographical positioning system (GPS) receiver.

5. An assembly according to claim 4, wherein the wireless computational device comprises a cell phone.

6. An assembly according to claim 5, wherein the GPS receiver is incorporated into the cell phone.

7. A method for displaying geographical information to a subject including the steps of:
determining positional data indicating a line of sight of the subject;
retrieving, by means of a cellular telecommunications network, geographical data corresponding to the positional data from a database; and
superimposing a display corresponding to the geographical data into the visual field of the subject.

8. A method according to claim 7, wherein the step of determining positional data includes determining the attitude of a headset worn by the subject.

9. A method according to claim 7, wherein the step of determining positional data includes determining the geographical location of the subject.

10. A method according to claim 7, wherein the step of determining positional data includes tracking the eyeball of the subject.

11. A method according claim 7, further including updating the data source with a geographical position of the subject.

12. A method according claim 7, further including transmitting a filter parameter to the database.

13. A method for displaying geographical information to a subject including the steps of:
determining positional data indicating a line of sight of the subject with reference to geographical location of the subject, attitude of a headset worn by the subject and by tracking of an eyeball of the subject;
retrieving, by means of a cellular telecommunications network, geographical data corresponding to the positional data from a database; and
superimposing a display corresponding to the geographical data into the visual field of the subject.
